(19) United States
(12) Patent Application Publication
(10) Pub. No.: US 2013/0092093 A1
(43) Pub. Date: Apr. 18, 2013

(54) FISH TANK WITH ACTIVE DISPLAY

(71) Applicant: Dale G. Potts, Las Vegas, NV (US)

(72) Inventor: Dale G. Potts, Las Vegas, NV (US)

(21) Appl. No.: 13/276,003

(22) Filed: Oct. 18, 2011

(51) Int. Cl. A01K 63/00

(52) U.S. Cl. 119/247

(57) ABSTRACT

A fish tank has an integral or attached active display. The fish tank provides an area for live creatures (e.g. fish, mollusks, reptiles, birds, etc.) and the display is filled with, for example, a background image or video, adding to the depth of view, the complexity of view and aesthetics of the fish tank. Any type of display is anticipated as well as any type of image displayed on the display, including television, computer screens, still images, video images, etc.

### FIELD

This invention relates to the field of home and office décor and more particularly to a fish tank with integrated display.

### BACKGROUND

Many homes and businesses have fish tanks as part of their décor. Besides the aesthetic qualities of most fish tanks, many believe watching fish swimming in the tanks provides relaxation and comfort, perhaps being therapeutic and lowering one's blood pressure.

Fish tanks include a sealed compartment for holding the water with at least one side through which the contents are visible. Fish tanks are typically filled with fresh water or salt water, depending upon the variety of aquatic creatures kept in the fish tank. Pumps, heaters, coolers, lights, and filters are often provided to control the clarity and temperature of the water and provide light for the aquatic creatures. In addition to the aquatic creatures, fish tanks typically contain ornaments, coral and gravel, providing aesthetic qualities and resting places for the aquatic creatures.

Some fish tanks have more than one side through which the contents are visible, such as a fish tank mounted in a wall through which the contents are visible from rooms on both sides of the wall. Some fish tanks are mounted in a wall and have only one side through which the contents are visible. When fish tanks are mounted in a wall in such a way, the back surface of the tank is typically a single color such as black or blue. This back surface ends the field of view and provides little aesthetic value. To improve the aesthetics of some “dead-ended” fish tanks, often a printed sheet is affixed to the dead-ended surfaces depicting still images of other fish, coral, sand, etc.

What is needed is a fish tank that has an active display on at least one inside surface.

### SUMMARY

A fish tank with an integral or attached display provides an area for live creatures (e.g. fish, mollusks, reptiles, birds, etc.) and an active display onto which a background image or video is displayed, adding to the depth of view, the complexity of view and aesthetics of the fish tank. Although described with images related to the creatures within the fish tank, any image/video is anticipated. For example, a movie, computer graphics, etc.

In one embodiment, a housing for containing creatures is disclosed including at least one side made of a transparent and/or opaque material for viewing the creatures and a display. The display interfaced to the housing such that an image presented on the display is visible through at least one of the at least one sides made of the transparent and/or the opaque material.

In another embodiment, a fish tank for containing creatures is disclosed including a housing for containing the creatures (e.g. fish) and a device for displaying images on at least one surface of the fish tank. The housing has at least one side made of a transparent and/or opaque material for viewing the creatures. The device for displaying the image displays the image on at least on of the at least one side.

In another embodiment, a fish tank for containing creatures is disclosed including a housing for containing creatures and a display. The housing has a floor, two transparent sides, a front transparent side and a rear transparent side. The display is interfaced to the rear transparent side such that an image presented on the display is visible through at least the front transparent side.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a side plan view of a fish tank with display panel.

FIG. 2 illustrates a front plan view of a fish tank with display panel.

FIG. 3 illustrates a perspective view of a fish tank with display panel.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, the term “fish tank” refers to a confined vessel that contains and confines creatures (aquatic or non-aquatic) and any amount of water needed to sustain the lives of those creatures. Although usually used to confine and contain fish within water, some fish tanks are used to confine and contain other pets such as hamsters, birds, snakes, etc. Such fish tanks are typically sealed to prevent leakage, prevent escape of the creatures and have various air and/or water recirculation systems as needed to sustain the lives of the aquatic creatures contained there within. Fish tanks come in many different sizes, shapes and colors, with and without visible frames. The simplest fish tank is a fish bowl, often used as a home for gold fish. More elaborate fish tanks are often rectangular and integrated into home or office walls and/or furniture. Although called a “fish tank,” such vessels are often the home of many other aquatic creatures that are not classified as fish such as mollusks, reptiles, etc. Not withstanding, the fish tank disclosed here within is any such tank and is not restricted in any way to a vessel that contains only fish. There is no requirement that any living creatures be present in the disclosed fish tank.

Throughout the remainder of this disclosure, for brevity purposes, the discussion will use an exemplary rectangular fish tank. This is an example of one type of fish tank, and the disclosed system is not limited to any particular size or shape of fish tank.

Throughout the remainder of this disclosure, again for brevity purposes, the term “display” will be used to refer to any type of digital or analog display currently available or available in the future, including, but not limited to, flat-panel displays, LCD flat panel displays, Plasma flat-panel displays, LED flat-panel displays, organic LED flat-panel displays, monitors, cathode-ray tubes (CRT), projection displays, projection TVs, and any known or future display technology such as holographic displays. The display is driven from any source, known or future, such as a television receiver (e.g., a TV), a computer (e.g. Internet content), a controller (e.g. content from storage such as DVD, CD, BluRay, flash memory, disk storage, etc.).

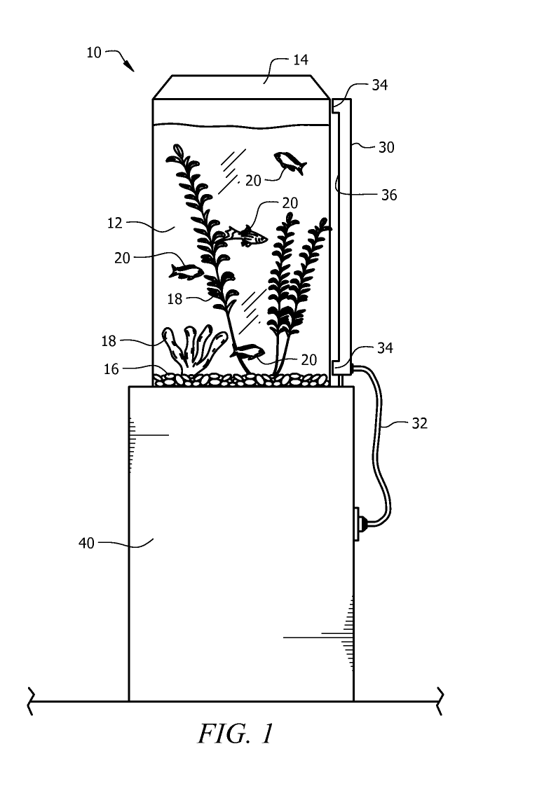

Referring to FIGS. 1, 2 and 3, views of a fish tank 10 with display panel 30 is shown. Although shown with fish 20 swimming in water 12, fish tank decorations 18 and gravel or sand 16, any contents are anticipated for the fish tank 10 including an empty fish tank 10. The display 30 provides background and/or foreground images that, in some cases, avoid the need for live creatures within the fish tank 10. Although any size, shape, and construction of the fish tank 10 is anticipated, the examples shown are generally rectangular. In some embodiments, a cover 14, either lighted or not, is provided to prevent escape of any creatures from within the fish tank 10 or invasion of any predators into the fish tank 10. For brevity purposes, the typical optional water circulation, filtration, heater, and/or cooler are not shown.

The display 30 is any known or future display technology, including, flat-panel displays, LCD flat panel displays, Plasma flat-panel displays, LED flat-panel displays, monitors, cathode-ray tubes (CRT), projection displays, and any known or future display technology. The display 30 is not limited in any way and both color or black/white displays as well as 2-dimension and 3-dimension displays are anticipated. Most displays have a bezel 34, though there is no requirement that the display has a bezel 34 and in some embodiments, the display panel 36 itself is interfaced directly to the side surface of the fish tank 10. Although most display panels 36 have very thin glass layers that are not capable of withstanding any significant pressure from water 12, it is fully anticipated that, given a different construction of the display panel 36, the glass surface of the display panel 36 becomes the side surface of the fish tank 10. Of course, in such, the glass surface of the display panel 36 is structurally sound and sealed to prevent leaks into the electronics of the display 30. One example of such a display 30 would be a CRT, which typically has a thick, sturdy glass viewing surface that is already capable of withstanding pressure of water from the fish tank 10.

In embodiments in which the display 30 is a projection display 30, it is anticipated that the image is projected on a surface of the fish tank 10 from above or in front of the surface or, alternately, the surface of the fish tank 10 is opaque and the image is projected from the rear of the surface. An example of the front surface projection display includes a projection lens, optionally disguised as an ornament within the fish tank 10, projecting an image on a surface of the fish tank 10. In this example, the surface of the fish tank 10 onto which the image is projected is preferably opaque or clear with a solid background such as a white background.

In some examples (as shown), the display panel 36 is separated from the side of the fish tank 10 by an air gap though it is also anticipated that the display panel 36 be flush with the side of the fish tank 10.

Also, even though one display 30 is shown attached to a back surface of the fish tank 10, any number, configuration, and location of displays 30 are anticipated such as displays 30 on three sides or displays on three sides, top and bottom, etc.

The display is provided with power 32 and a video and/or audio source (not shown) as known in the industry. In some examples, the display 30 includes an integrated media player (not shown), accepting content (e.g. video content) from one or more sources of content such as DVD disks, CDs, BluRay disks, flash memory, hard drives. In some examples, the display 30 receives content from remote sources such as a television signal or a network connection to a computer, as known in the industry.

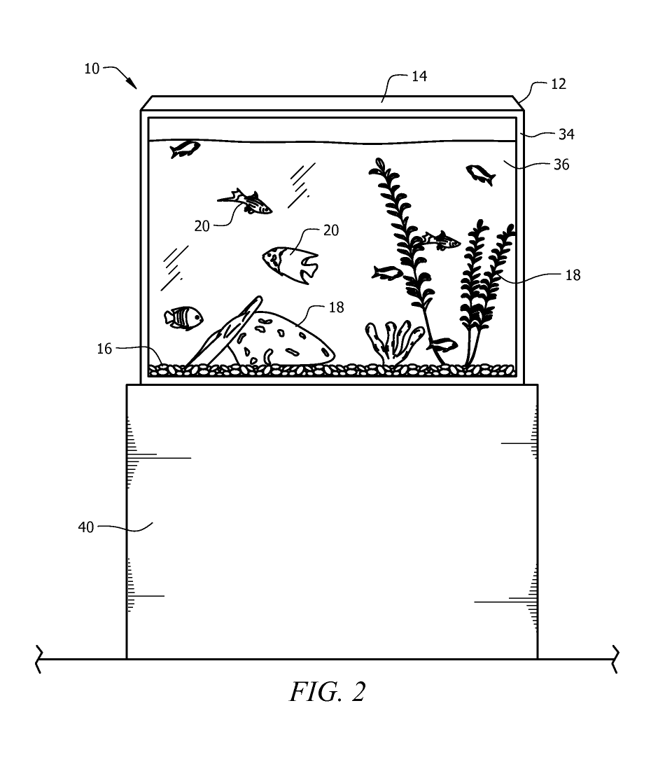

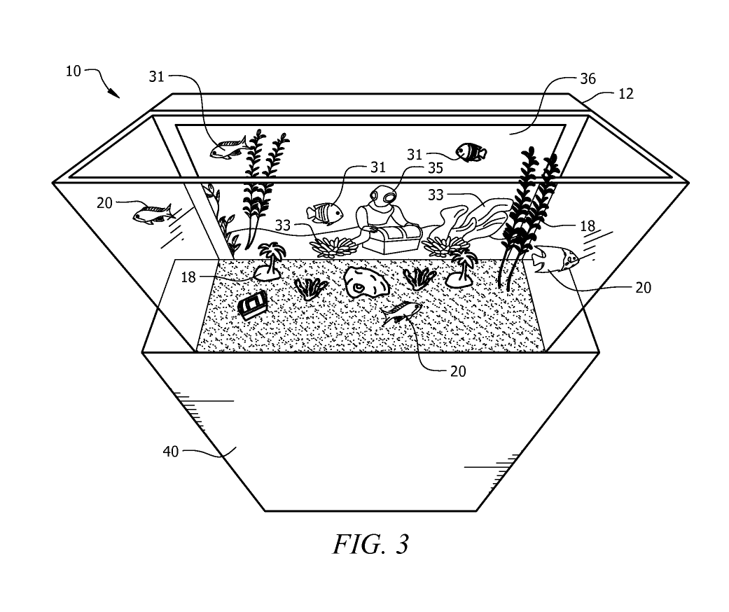

In FIGS. 1 and 2, the display 30 is not active and the fish 20, decorations 18 and gravel 16 are items within the fish tank 10. In FIG. 3, the display 30 is active and the fish 31, coral 33 and deep-sea diver 35 are displayed on the display 30, either as still images or motion images. Although living creatures (e.g. fish 20) are shown present in the fish tank 10, there is no requirement for any particular type of living creature to be present in the fish tank 10. When not living creatures are present in the fish tank 10, it is anticipated that video images on the display 30 coupled with the dimensions of the fish tank 10 provide the appearance that living creatures are present within the fish tank 10.

Any type of image displayed on the display 30 is anticipated including still images (e.g. a still image of a coral reef) as well as video images (e.g. an image of fish swimming around a coral reef). By adding depth of background and, optionally, additional images of additional creatures (e.g. fish swimming in the images displayed on the display 30), the fish tank 10 will appear to have more depth and more creatures (fish) than are present within the water 12.

Any construction of the fish tank 10 is anticipated, with or without a frame, with or without water 12, rectangular square or any other shape, any material such as glass, plastic, etc.

Although shown on a stand or base 40, any support structure is anticipated, including having the fish tank 10 with display 30 built into a wall or enclosure.

There are many advantages in having one or more displays 30 coupled to a fish tank 10, including, but not limited to: providing a vibrant, colorful, bright background to the existing creatures and items typically found in fish tanks 10; providing depth of view to the fish tank 10; providing images or video of supplemental creatures/fixtures to the fish tank 10 (e.g. images and/or video of fish 31, coral, etc.) and providing possible beneficial health benefits to creatures 20 within the fish tank 10. Just as humans having pets has beneficial health benefits, having images of additional creatures 31 is also beneficial to the creatures 20 living in the fish tank 10. Perhaps an image of an occasional predator will provide some cardio-vascular exercise to the creatures such as to fish 20 in the fish tank 10.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A fish tank for containing creatures, the fish tank comprising:
a housing for containing creatures, the housing having at least one side made of a transparent and/or opaque material for viewing the creatures; and
a display, the display interfaced to the housing such that an image presented on the display is visible through at least one of the at least one sides made of the transparent and/or the opaque material.

2. The fish tank of claim 1, wherein the housing is rectangular and a viewing surface of the display interfaces to a first side of the at least one side.

3. The fish tank of claim 1, wherein the display is selected from the group consisting of a LCD flat-panel display, a LED flat-panel display, an organic LED flat-panel, a plasma flat-panel display, and a cathode ray tube.

4. The fish tank of claim 1, wherein the display is a projection display.

5. The fish tank of claim 1, wherein the display is a video display.

6. The fish tank of claim 1, wherein the display is back lighted.

7. A fish tank for containing creatures, the fish tank comprising:
a housing for containing creatures, the housing having at least one side made of a transparent and/or opaque material for viewing the creatures; and
means for displaying an image on at least one of the at least one side made of the transparent and/or the opaque material.

8. The fish tank of claim 7, wherein the means for displaying is a flat panel display, the housing is rectangular and a viewing surface of the display interfaces to a first side of the at least one side made of the transparent and/or opaque material.

9. The fish tank of claim 8, wherein the display is selected from the group consisting of a LCD flat-panel display, a LED flat-panel display, an organic LED flat-panel, a plasma flat-panel display, and a cathode ray tube.

10. The fish tank of claim 7, wherein the means for displaying is a projection display.

11. The fish tank of claim 7, wherein the means for displaying is a video display.

12. The fish tank of claim 7, wherein the means for displaying is back lighted.

13. A fish tank for containing creatures, the fish tank comprising:
a housing, the housing having a floor, two sides, a transparent front surface and a transparent rear surface; and
a display, the display interfaced to the transparent rear surface such that an image presented on the display is visible through at least the transparent front surface.

14. The fish tank of claim 13, wherein the housing is rectangular and a viewing surface of the display abuts directly against the transparent rear surface.

15. The fish tank of claim 13, wherein the display is selected from the group consisting of a LCD flat-panel display, a LED flat-panel display, an organic LED flat-panel, a plasma flat-panel display, and a cathode ray tube.

16. The fish tank of claim 13, wherein the display is a video display.

17. The fish tank of claim 13, wherein the display is back lighted.

18. The fish tank of claim 13, further comprising gravel situated on the floor of the housing.

19. The fish tank of claim 13, further comprising decorative objects situated on the floor of the housing.

20. The fish tank of claim 13, wherein the housing is at least partially filled with water and there is at least one live fish within the water.
